(19) United States
(12) Patent Application Publication
(10) Pub. No.: US 2008/0114671 A1
(43) Pub. Date: May 15, 2008

(54) Cascade bidding

(75) Inventors: Amit Goel, San Jose, CA (US); Christopher Scott Loper, Sunnyvale, CA (US); Sohilraj A. Gilani, Sunnyvale, CA (US); Christopher Maliwat, San Francisco, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc.

(21) Appl. No.: 11/595,219

(22) Filed: Nov. 9, 2006

(51) Int. Cl. G06Q 30/00

(52) U.S. Cl. 705/37

(57) ABSTRACT

Some embodiments may provide a method and a system for receiving a first limit price, associated with a bidder, on a first auction-format listing, receiving a second limit price, associated with the bidder, on a second auction-format listing, making a first determination as to whether a first condition exists that prevents a first winning bid from being placed on behalf of the bidder on the first auction-format listing, the first winning bid being at least as favorable to the bidder as the first limit price, and based on the first determination being in the affirmative, selectively making a second determination as to whether a second condition exists that prevents a second winning bid from being placed on behalf of the bidder on the second auction-format listing, the second winning bid being at least as favorable to the bidder as the second limit price.

### TECHNICAL FIELD

The present application relates generally to the technical field of methods and systems to perform data processing.

### BACKGROUND

In recent years, the Internet has made possible online auction services. The unique nature of the Internet as a worldwide, low-cost, and high-speed medium of communication as well as its ability to deliver various types of media, including text and images, allows people who are widely separated geographically to offer items for auction and, via an online auction facility, to receive bids from users located throughout the world. These auctions are often facilitated by online auction houses that maintain user accounts (in their roles e.g., as bidders and/or sellers), auction-format listings of items, services, etc, bidding history, and other data.

Users typically browse an online auction facility's web site where listings of various items available for bid, including descriptions, current bid, auction closing time, etc. are displayed. Once logged in, users can place bids on one or more items, the bids typically representing binding contracts to purchase the item if the user is found to have eventually placed the highest bid.

### BRIEF DESCRIPTION OF THE DRAWINGS

Some embodiments are illustrated by way of example and not limitation in the figures of the accompanying drawings in which:

FIG. 1 is a block diagram of a system for implementing cascade bidding, according to an example embodiment.

FIG. 2 is a flow chart illustrating a process for creating and initializing a bid group, according to an example embodiment.

FIG. 3 is an illustration of a user interface for creating a bid group, according to an example embodiment.

FIG. 4 illustrates an example of a user interface for entering limit prices on listings in a bid group, according to an example embodiment.

FIG. 5 illustrates an example user interface to confirm the settings of a bid group, according to an example embodiment.

FIG. 6 is a flowchart illustrating a process of bidding on a bidder's behalf on an active listing, according to an example embodiment.

FIG. 7 illustrates a process that may be carried out when the auction on the active listing ends, according to an example embodiment.

FIG. 8 shows an example user interface that may be used to present the status of the cascade bidding within a bid group to the user to whom the bid group belongs, accordingly to an example embodiment.

FIG. 9 illustrates a user interface window, screen, or webpage that may be used to add a listing to a new or existing bid group, according to an example embodiment.

FIG. 10 illustrates database tables that may be used in the implementation of cascade bidding, according to an example embodiment.

FIG. 11 is a flowchart showing in summary a cascade bidding process within a cascade bidding system, according to an example embodiment.

FIG. 13 shows a summary flowchart for a process for transmitting data facilitating cascade bidding on behalf of the bidder, according to an example embodiment.

FIG. 14 is a network diagram depicting a client-server system within which one example embodiment may be deployed.

FIG. 15 is a block diagram illustrating multiple applications that, in one example embodiment, are provided as part of the networked system of FIG. 14.

FIG. 16 is a high-level entity-relationship diagram, illustrating various tables that may be maintained within the databases of FIG. 14 and that are utilized by and support some applications illustrated in FIG. 14.

FIG. 17 provides further details regarding pertinent tables that are shown in FIG. 16.

FIG. 18 shows a diagrammatic representation of machine in the example form of a computer system within which a set of instructions, for causing the machine to perform any one or more of the methodologies, processes, or operations discussed herein, may be executed.

### DETAILED DESCRIPTION

Example methods and systems to facilitate cascade bidding are described. In the following description, for purposes of explanation, numerous specific details are set forth in order to provide a thorough understanding of example embodiments. It will be evident, however, to one skilled in the art that the present invention may be practiced in other embodiments without these specific details.

Introduction

When a user goes to an online auction facility's web site to bid on auction format listings, he or she may be looking for a particular item. When the user searches for such an item, he or she may be presented with a list of many identical or similar items up for auction, with each of the items' auctions ending or closing at a different time and date. Many of these items may be acceptable to the user. The user is interested in purchasing only one (or a few) of these items. But to make sure he or she wins one of the items, the bidder needs to keep track of not only the item he or she has bid on but not yet become the winning bidder of, but also the other items that would be acceptable, so that in case he or she is not the high bidder on the first acceptable item, he or she can bid on the other items, one by one, in an attempt to eventually be the winning bidder on at least one. This may be a time-consuming process that involves keeping track of numerous items up for bid, their auction end times, and their current high bids.

This specification describes example systems and methods for carrying out a process which may be termed “cascade bidding.” Cascade bidding is a process which may be used in conjunction with online auctions. In cascade bidding, a bidder (which may be, for example, a person or an automated procurement application running on a machine) may select two or more items (or other listings, such as services, etc.) that are up for auction to place in a “bid group” and specify for each selected item a limit price (e.g., maximum price that the bidder is willing to pay for that item.) In some embodiments, the bidder may wish to “win” (e.g., be the high bidder and thus be able to purchase) exactly one item out of the group while in some other embodiments the bidder may wish to win more than one of the items from a bid group of selected items. In either case, the bidder does not care exactly which one or more of the items in the bid group are won.

In discussing auctions, the terms “current bid”, “winning bid” and “limit price” may be used. In an ascending auction a seller may offer an item or other listing such as a good or a service for bid to a number of bidders. The seller may specify a “reserve price” indicating the minimum that the seller is willing to accept for the item. Bidders, either directly or through “proxy” (e.g. automatically placed bid) mechanisms such as those described in some examples of cascade bidding in this specification, may place bids with the requirement that each bid is placed higher than the previous bid. The most recently placed bid may be termed a “current bid.” In some auctions which multiple copies or instances of the same item are available, there may be multiple current bids.

In the context of such an ascending auction, a “limit price” may be the maximum price that a bidder is willing to pay for the item. As bidding progresses, the price of the current bid becomes increasingly less favorable to the bidder (and correspondingly more favorable for the seller.)

On the other hand, in other types of auctions, such as for example, a reverse auction, a buyer may wish to purchase an item at the lowest possible price and may place a listing or other description of the item desired for purchase on a network-based publication system. In some examples of such auctions, sellers in the role of bidders may bid against one another to offer an item, with each bid having a lower price than the previous bid. In such an auction a bidder's limit price may be the minimum price for which the bidder is willing to sell the item.

Thus, in ascending auctions a price A may be considered more favorable to a bidder than price B, if price A is less than price B. On the other hand, in a reverse auction a price A may be considered more favorable to a bidder than a price B, if price B is lower than price A. As alluded to above, these favorability relations are reversed for the bidder's counterparty, such as a seller in an ascending auction, and thus it is important to specify when comparing the favorability of prices associated with bids to specify to which party the price is more or less favorable.

Once the bidder has transmitted (such as via the Internet using internet protocol messages, or via other mechanisms such as by telephone, or internet telephony) or otherwise provided the list of items to be included in the bid group and the corresponding limit prices to the online auction system or other network-based publication system, the system may begin bidding automatically on the items in the user's group in the order of the auction closing times of the items in the group.

For example, suppose that a user created a bid group containing items for auction A, B and C whose closing times are ordered with item A closing first and item C closing last. Suppose further that the bidder had entered a limit price of $100 for all three items. If the items are offered as an ascending auction, the system may begin by placing a bid on item A on behalf of the user and as other system users bid on item A, the system would place increasing bids on behalf of the user on item A up to the user's maximum or limit price (e.g., $100). Eventually one of two outcomes may occur with respect to item A. Either the bidder may by virtue of one of these automatically-placed or “proxy” bids as the winner of item A, or the system may determine that it is not possible for the user to win item A and will then begin to attempt to place proxy bids on behalf of the user on item B. Some examples of situations in which the system may determine that the user cannot win item A include another bidder outbidding the user's maximum bid in a system where the bidder cannot revise the limit bid on a particular item, or cancellation of the auction of item A by the seller or the auction system administrators.

This bid cascading process may continue until all the items in the user's group have been either bid on or determined to not be winnable for the user or until the user has won the number of items specified when the bid group was created. In some embodiments a user may add more items to a bid group or may change the limit prices on one or more items in the group, subject to certain constraints as described further below.

It will be appreciated that the creation and later modification of a bid group and the observation of the process of cascade bidding may be through a web interface, a non-web graphical user interface or programmatically by an application programming interface API or other mechanism. In some embodiments a user may set up multiple bid groups and instruct the auction system to commence bidding on items in a particular group in response to one or more items being won in another group. This feature may be used when an item from one group is only of interest to the bidder when one of the items from another group has actually been won.

Cascade bidding may have several example technical benefits. For example, because a user may need to log in to a network-based publication system less frequently when using cascade bidding as compared to monitoring each auction-format listing of interest, reduction of communication bandwidth and/or processor usage may be achievable for a network-based publication system supporting cascade bidding. Another example technical benefit of cascade bidding may include a reduction of emails sent to users who have been outbid, leading to a reduction of communication bandwidth required of network-based publication systems for handling email traffic and reduction of storage required to maintain logs of emails sent.

Example System Facilitating Cascade Bidding

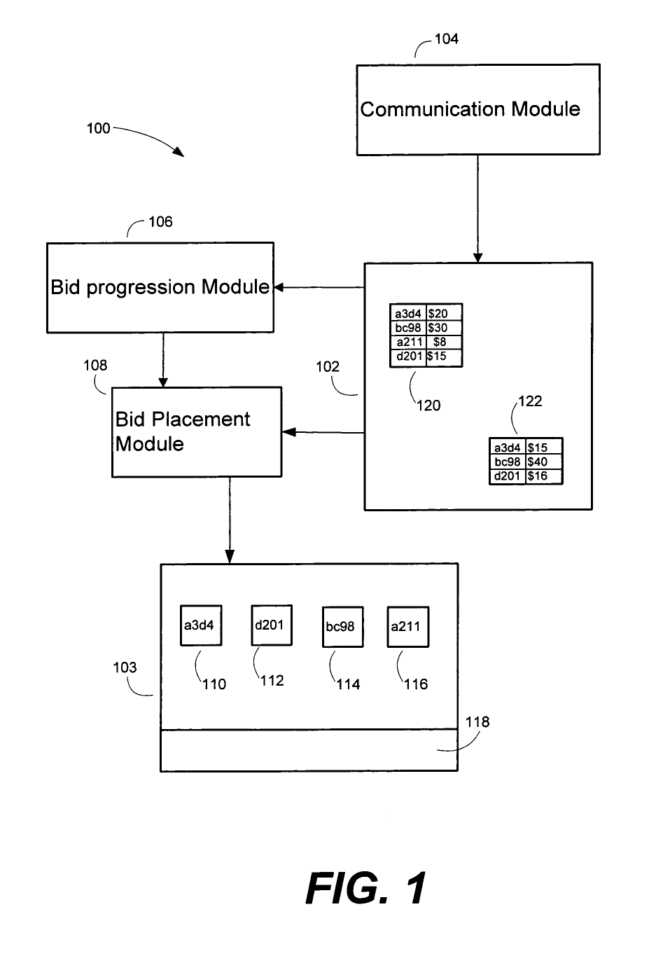

FIG. 1 is a block diagram of a system 100 for implementing cascade bidding, according to an example embodiment.

The system 100 includes a store 102 for storing bid group information, a store 103 for storing auction format listing data and current bid and bid history data, a communication module 104, a bid progression module 106 and a bid placement module 108.

The communication module 104 may receive bid group information from a user in the role of a bidder in a network-based publication system that provides auction-format listings and auction-format bidding. This bid group information may include information allowing the initial creation of one or more bid groups and the receiving of information identifying the auction format listings to be included in one or more bid group(s). The communication module 104 may include facilities for receiving initial and updated limit prices and information for updating, expanding, deleting, renaming or other operations on bid groups.

The bid progression module 106 may be used to determine whether and when proxy bids may be placed on behalf of the bidder on auction-format listings and may be used to determine when a condition exists that will prevent a winning bid from being placed on a particular auction format listing on behalf of the bidder, and thus that bidding on behalf of the bidder be considered on a succeeding listing in a bid group.

The bid placement module 108 may be used to place proxy bids on auction format listings in response to determination of the bid placement module and by using bid group information in store 102.

Two bid groups, 120 and 122, are illustrated as stored in store 102. Taking bid group 120 as an example it will be observed that the first column includes identifiers for various auction format listings and the right column includes a limit price denoting the maximum the bidder is willing to bid for the identified item.

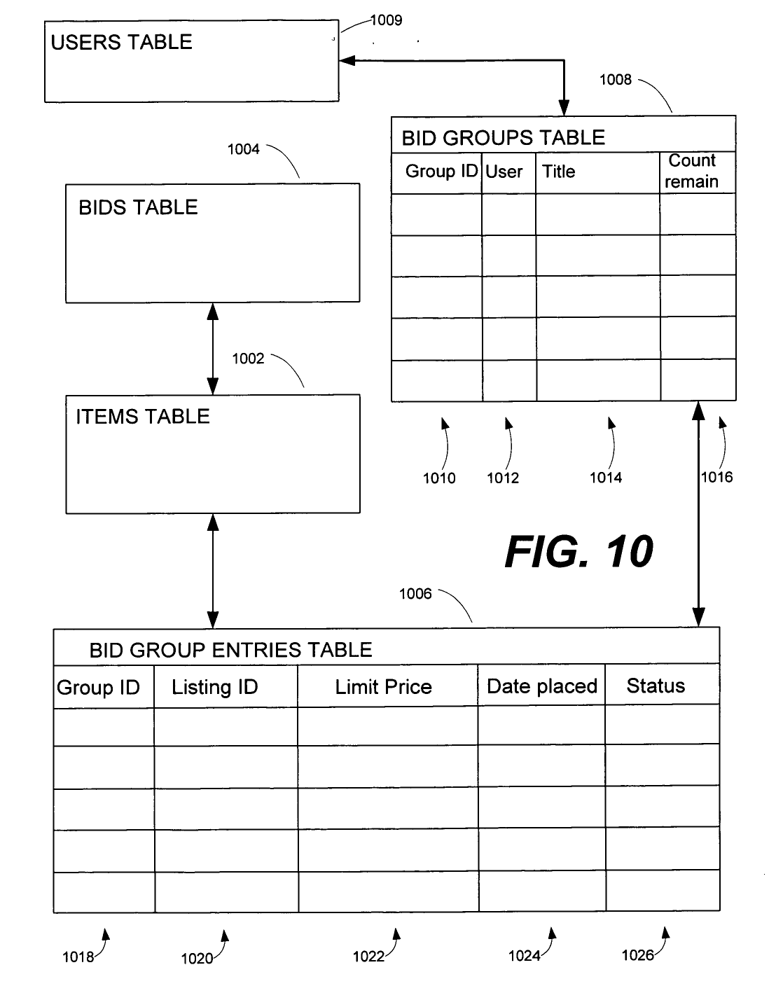

The store 103 diagrammatically includes four auction format listings, 110, 112, 114 and 116 as well as a storage area 118 for current bid data. The stores 102 and 103 may be implemented using relational database tables or other data storage formats. An example embodiment is described below is more detail with respect to FIG. 10.

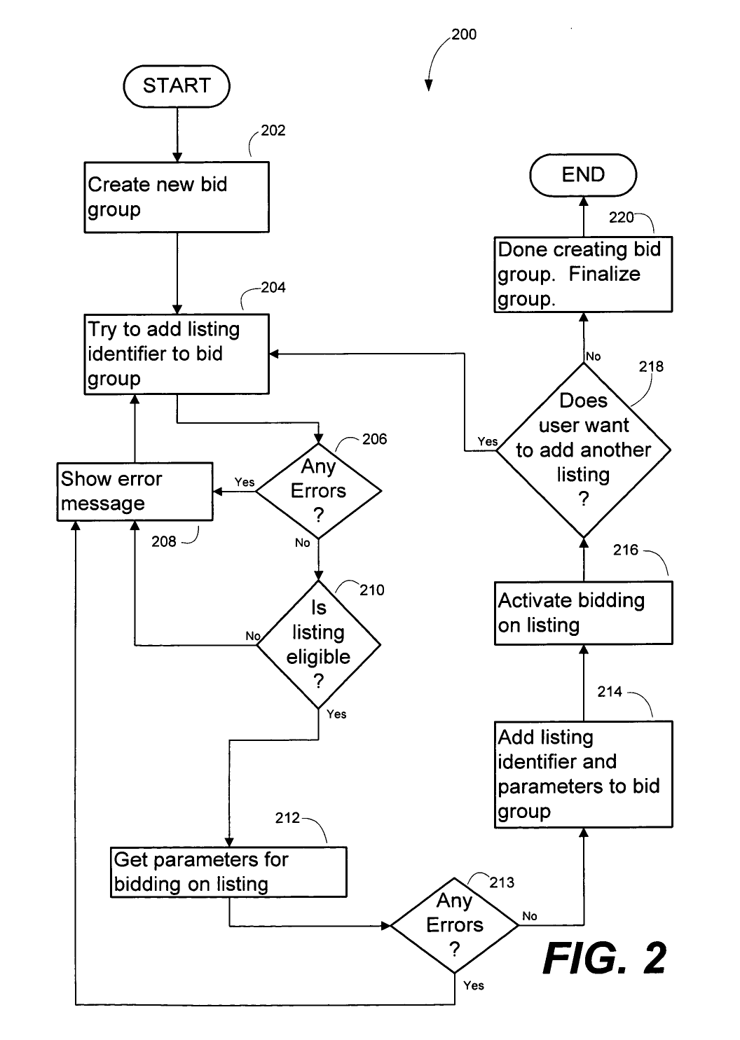

FIG. 2 is a flow chart illustrating a process 200 for creating and initializing a bid group, according to an example embodiment.

At block 202 a new bid group may be created. In some embodiments this operation may be carried out by a communication module in response to receiving a request from a bidder to create the new bid group. The new bid group may be stored in a relational database or other storage, as described below with respect to FIG. 10. At block 204 an attempt to add a listing identifier to a bid group to allow proxy bidding on that listing may be made. The operation of block 204 may also be carried out by the communication module; in some embodiments a user, such as through a web interface or an application programming interface (API), may provide the identifier of the listing to be added to the bid group. At block 206 the request to add the listing identifier to the bidding group may be evaluated to determine if there are any errors associated with attempting to add the listing identifier to the bid group, for example, if the listing identifier is already contained in the bid group. At box 206 a check for errors or other issues related to the bidder's (e.g., buyer's) eligibility may be carried out. For example, a determination may be made as to whether the bidder meets the feedback rating required by the entity that placed the listing, whether the bidder is pre-approved to bid on an auction format listing requiring pre-approved bidders, or whether the entity that placed the listing ships to the bidder's country, if the listing is for an item.

At decision box 210 the listing is evaluated for its eligibility for placement into the bid group. For example, if the bidding on a listing has already ended or if the listing has been cancelled by the seller. If the selected listing is ineligible, the bidder is ineligible to bid on the selected listing, or there are any errors in adding the listing identifier to the bid group, an error message may be presented to the user at block 206, such as by showing an error message on a web page or transmitting an error message through an API. The error message transmission of block 208 may be facilitated by the communication module. In some embodiments, a bidder may be ineligible to bid on the selected listing because, for example, the bidder has not met registration requirements necessary to bid on the selected listing, or the bidder may not a sufficiently high feedback rating (e.g., as compiled or created via reputation application 1508) to bid on the selected listing as per the requirements established by system administrators or the entity offering the selected listing.

Decision box 210 may also evaluate the selected listing may be added (e.g., via adding its identifier) to the bid group based on what may be termed ‘bid group-centric’ criteria. For example, the selected listing may not be added to the bid group if doing so would cause the count of items in the bid group to exceed a predefined maximum count, or would cause the sum of the current bid prices on listings on the bid group to exceed a predefined maximum, or would violate other limits on bid groups in general or specific to the bidder.

On the other hand, if the listing whose identifier is to be added to the bid group by the user has no errors or eligibility issues the system may obtain the parameters for the listing from the user. At block 212 the parameters for bidding on the listing may be received, such as for example by the communication module. The parameters may include the limit price for bidding on the listing. Some other examples of parameters for bidding on the listing include may include a quantity for a listing offered as a multi-unit auction, a minimum feedback rating, which, if the entity offering falls below, is to cause the listing to be skipped (e.g., in response to determination of block 716, described below), and whether the bidder wishes to have the system proxy-bid on a listing if it has been revised since it was added to the bid group.

At block 213, a determination as to whether any parameter-related errors have occurred may be made. For example, an error may have occurred if a limit price entered by bidder for an auction format listing is more favorable to the bidder (e.g., lower, in an ascending auction) than a reserve price on the listing. If error(s) are determined at block 213, processing may continue to block 208. Otherwise, processing may continue to block 214.

In some embodiments, when a bidder creates two or more bid groups, a particular listing offered for single-unit auction may be included in only one bid group created by a bidder and that an attempt to add the listing to a second bid group without removing it from a first bid group may be an error susceptible for detection at decision box 206. In some embodiments, a particular listing offered for multi-unit auction of quantity X available for purchase, it may be an error susceptible to detection at decision box 213 if the bidder enters a desired count to win on that multi-unit auction listing that causes the total desired count, over all the bidder's bid groups, to win on that multi-unit auction listing to be greater than X.

At block 214 the listing identifier and parameters corresponding to the listing may be added to the bid group. Once a listing identifier and the parameters have been added to the bid group, in some embodiments bidding may be activated immediately at block 216 on the listing, while in some embodiments the bidding on the first listing in the bid group may not begin until the user has completed populating the bid group. At decision box 218 a determination may be made as to whether the user would like to add another listing to the bid group and, if so, the process for adding a listing may be repeated. If not, the creation of the bid group may be considered finished and may be finalized at box 220, such as for example, by receiving an indication from the user of the number of items the user desires to win.

The various modules described herein may be included within a system for carrying out cascade bidding; such a system may in some embodiments be termed a “bid manager.”

Example User Interfaces for Bid Group Creation

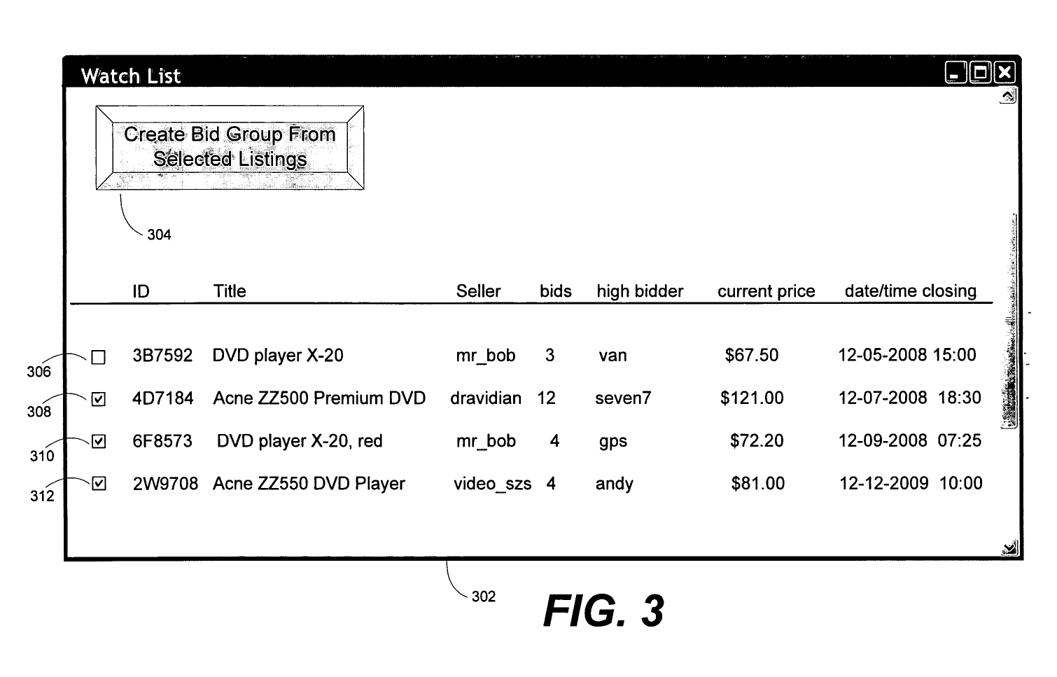

FIG. 3 is an illustration of a user interface for creating a bid group, according to an example embodiment.

In some embodiments, a user of a network-based publication system such as an online auction system may be able to create a watch list that includes a list of items on which the user is potentially interested in bidding. An example of such a watch list is illustrated as it may be shown in a simplified form in a window 302 which may be displayed in an internet browser or similar application. In the example window 302 items of interest to a user are illustrated including an item ID, a title, an indication (e.g., a nickname) of a seller of the item, the number of bids that have been placed so far on the item, an indication of the identity of the high bidder who placed the most recent bid (e.g., current bid), the current price of the item indicating the highest bid received on the item thus far (e.g., the current bid price) and a date or date stamp indicating the time that bidding on the item will be closed.

In addition to the information about the various items on the user's watch list (which may also include other information such as a thumbnail image of each product), a check box associated with each item in window 302 is available to allow the user to select the items from the watch list to be included in a bid group. These check boxes are illustrated in FIG. 3 as 306, 308, 310 and 312.

Suppose, for the purposes of example, a user would like to include the last three items illustrated in window 302 in a bid group. To do so, the user may place check marks (e.g., by clicking a mouse when a mouse pointer is within a check box) in check boxes 308, 310 and 312 to select those items and then click on the button 304 to indicate the desire to create a bid group that includes the selected items.

In some embodiments, it may be an error for a user to select items or listings to be added to a bid group in which some pair of listings has an auction closing time less than a particular minimum time interval separate from each other, such as for example, ending within one second of each other. Once a user has clicked on button 304 or otherwise indicated the items or listings to be included in the bid group, the user may then enter limit prices on the various listings.

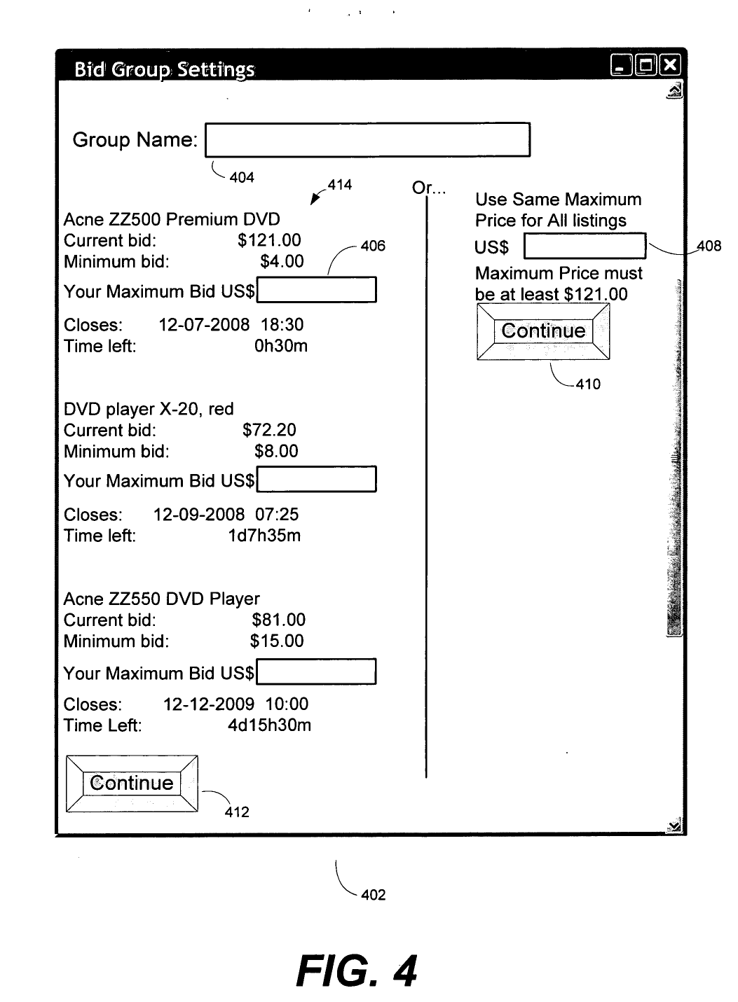

FIG. 4 illustrates an example of a user interface 402 for entering limit prices (e.g., maximum bid prices the user is willing to have the system bid on their behalf) on listings in a bid group, according to an example embodiment. In FIG. 4, an example user interface window 402 includes a number of elements and is illustrated as being divided generally into two side-by-side regions. In the left hand region, information is shown describing each of the listings that the user has requested to include in the bid group (e.g., via a user interface such as that shown in FIG. 3). For example, the first listing for the “16500 Premium DVD” is indicated as auction format listing 414. The left portion of the window may include text entry fields, for example field 406 to allow the user to specify a limit price such as, for example, a maximum bid in the case of an ascending auction. These text fields allow the user to specify a different limit price (e.g., maximum bid price) on each auction format listing in the bid group. The auction format listings may be listed in order of increasing auction closing time and may include not only a date stamp indicating the auction closing time but also an indication of the amount of time left until bidding closes on that auction format listing. If a user enters a maximum bid price less than the current bid price for a listing, or less than a reserve price, the system may display an error message. On the right side of the user interface window 402, user interface elements facilitating an alternative maximum bid price entry process may be provided to allow the user to use the same maximum price for all the listings included in the bid group. A text entry field for entering this common limit price (such as for example, a maximum price in which all the listings are an ascending auction format listing) is illustrated as text field 408. It will be appreciated that the price entered may be required to be higher than the highest current bid among the listings in the bid group. In addition, a text field 404 for entering a name for the newly-created bid group is provided.

Once the user interface window 402 has been filled out by the user, the user may click one or the other of the continue buttons 410 and 412 to activate the cascade bidding process on the newly created bid group.

In some embodiments, the system (such as via the bid progression module 106 and bid placement module 108) may begin bidding on behalf of a user as soon as possible, for example, bidding on the first listing in a bid group as soon as the bid group has been created, or bidding on later listings in the bid group as soon as it is determined that is appropriate (e.g., when the number of items desired remains positive and the bidding on the previous listing was not won on behalf of the user).

In some embodiments, users may specify when the system is to start bidding on their behalf, such as waiting until 10 minutes before the auction closing time for a particular listing before placing the first bid on behalf of that user on that listing, of waiting until a specified absolute time or time relative to the auction closing time to begin bidding on behalf of the user, e.g., proxy bidding. In those embodiments, the user interface 402 may provide a mechanism, such as a field, calendar mechanism or the like to facilitate the user input or editing of such an e.g., “scheduled bidding time” for one or more listings in the bid group.

In some embodiments in the process of setting up the bid group, the user may also be presented by a user interface element allowing the user to specify how many items out of the bid group the user ideally would like to purchase. For example, suppose the user has a house with two entertainment systems in it and the user wishers to purchase one DVD player for each entertainment system. In this example, the user may create a bid group including for example seven DVD players currently available for auction and wishes to purchase two. In this example, cascade bidding may be carried out by the system until the user has placed the winning bid on two items, or until the bidding has closed on all the items in the bid group, whichever occurs sooner.

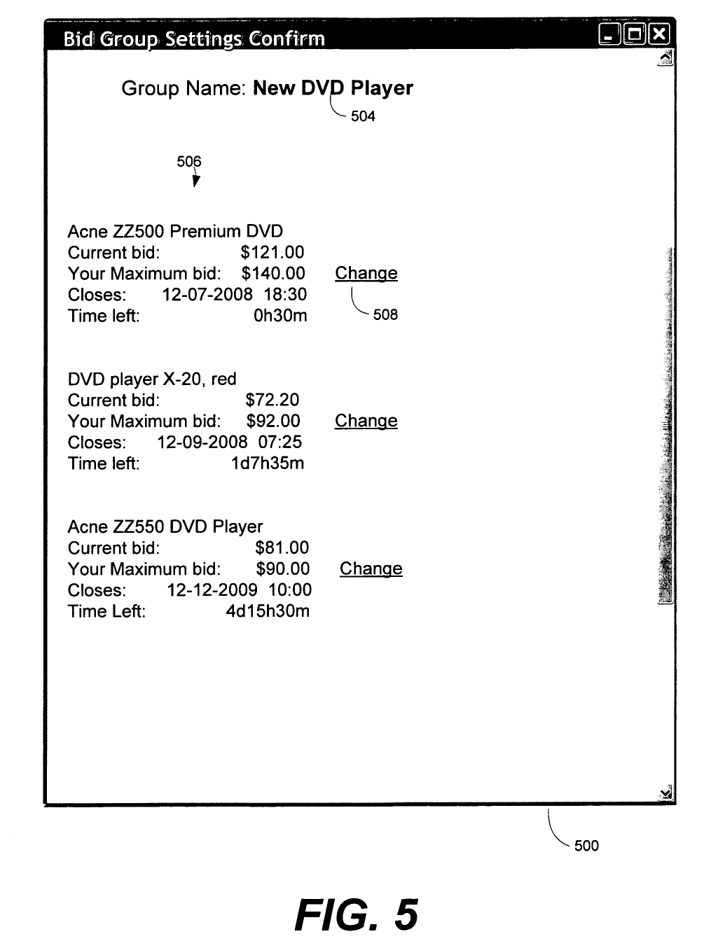

FIG. 5 illustrates an example user interface to confirm the settings of a bid group, according to an example embodiment.

In FIG. 5, the user interface window 500 illustrates a confirmation window or screen that may be illustrated after a user has set up a bid group. At 506, the various auction format listings included in the bid group are shown. Each of these blocks of information describing an auction format listing include the user's limit price such as a maximum bid and also may include a button or hypertext link, such as for example, hypertext link 508 to allow the user to navigate to a screen to change a particular limit price. In addition, the group name may be identified by a text label 504 as entered by the user.

In some embodiments, it may be possible for a user to add further items to an existing bid group once cascade bidding has commenced on that bid group. Such “replenishment” may be facilitated by user interfaces similar to those illustrated in the foregoing figures. Replenishment may be desirable if a user is finding it difficult to win items, or if new items of a type desired by the user are placed for auction during the course of the cascade bidding process.

In some embodiments, individual auction format listings may include a fixed price purchase option. This fixed price purchase option may allow a user to immediately win an auction by effectively placing a bid at a price specified by the seller that is (e.g., in an ascending auction) higher than the most recent (e.g., current) bid price. In some embodiments, the user may wish to indicate a willingness to pay the fixed priced on the last item in the bid group to be assured of obtaining at least one item in that bid group if the user does not win an earlier item in the bid group. In some embodiments in which the user desires to win more than one item in a bid group, such as for example, three items from a bid group including seven item listings, user interface elements may be provided to allow the user to indicate that if, for example, the user does not win at least one of the first four items in the bid group that the system is to bid the immediate purchase price on the remaining three items in the bid group to assure the user of obtaining the desired three items in the bid group. In some embodiments, some of the auction-format listings that include fixed-price purchase option may require immediate payment by a bidder. In those embodiments, such listings may be excluded from inclusion in a bid group if they require a bidder to make payment manually.

It will be appreciated that numerous variations on these foregoing fixed price and multiple desired item mechanisms may be implemented. It will be further appreciated that in some embodiments, cascade bidding my be designed to allow bidding on both ascending and reverse type auctions, as well as other auction formats (e.g., multi-unit auctions)

Listing Progression Example Processes

In the sections below, further example processes and user interfaces related to the cascade bidding process are illustrated. For the purpose of this specification, the term “active listing” may be used to refer to the auction format listing within a bid group that a network-based publication system (such as an online auction system) is bidding on, on a user or bidder's behalf. Initially, the first item listing within a bid group may be considered the active listing and the online auction system may bid on this first listing on behalf of the bidder until a condition is found to exist that prevents the system from placing a winning bid on behalf of the bidder on this active listing, for example, if the current bid in an ascending auction is higher than the bidder's limit price or if the bidder becomes ineligible to bid on the listing. If the bidder is in fact the winning bidder on the first listing in the bid group and the bidder has indicated a desire to win only one item from the bid group, the cascade bidding with respect to the bid group may terminate. On the other hand, if a condition is detected that prevents the bidder from winning the first item, the system (and in some embodiments, a bid progression module) may cause the second item in the bid group to become the new active item and may attempt to bid on behalf of the bidder on that second listing.

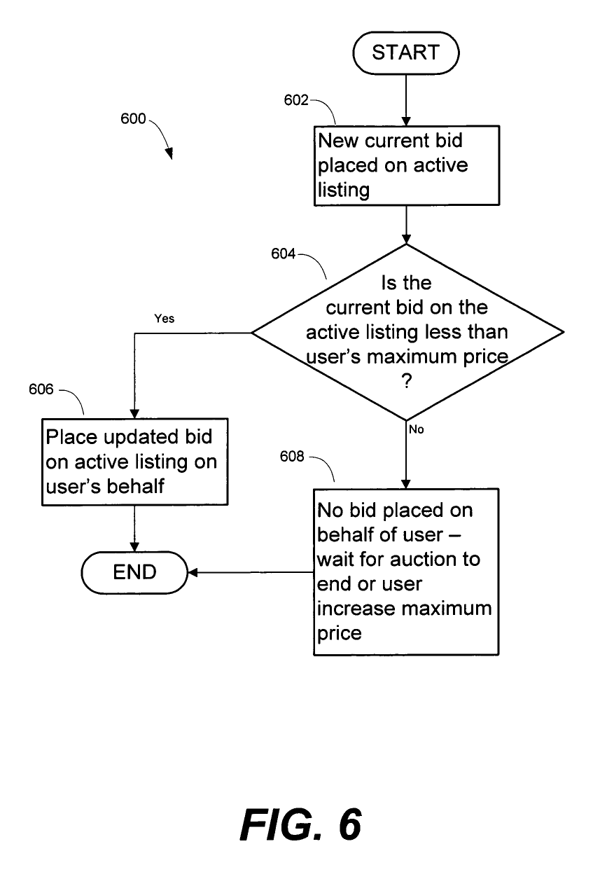

FIG. 6 is a flowchart illustrating a process 600 of bidding on a bidder's behalf on an active listing, according to an example embodiment.

At block 602, a new bid may be placed on the current or active listing within a bidder's bid group. This new bid may be placed manually by another bidder or may be placed on behalf of another bidder when the active listing is also included in a bid group belonging to the other bidder. This bid placement may be considered to be the action that invokes the process 600.

At decision box 604, a condition may be evaluated (such as by a bid progression module 106) as to whether the newly placed current bid price on the active listing is less than the user's maximum price. If this is the case, the system (such as by a bid placement module) may at block 606 place an updated bid on the active listing on the user's behalf with a price less than the user's maximum price but more than the current bid (in the case of an ascending auction.) In some embodiments, a listing may include multiple items in which case an updated bid placed on the user's behalf on the active listing may be equal to a current bid. Once the updated bid has been placed on the active listing on the user's behalf, the system may wait for other bidding to occur.

On the other hand, if the newly placed current bid is determined at decision box 604 to be, for example in the case of ascending auction, higher than the bidder's maximum bid price, then processing may continue at block 608 in which no bid is placed on behalf of the bidder. In this case, in some embodiments, the system may wait for the auction to end before making the next item in the bid group the active item, in case the bidder raises the maximum bid price on the current item before the auction ends on the current item. In some other embodiments, when a bidder is outbid on an active item, the bidder may not be given the opportunity to increase the limit price with respect to the active item and bidding on behalf of the bidder may immediately continue with the next item in the bid group becoming the active item.

In, for example, some of the latter embodiments described in the previous paragraph, a situation may occur in which auction format listings ‘X’ and ‘Y’ (where e.g., Y closes after X) are included in a bidder's bid group, the system has determined that the bidder cannot be a winning bidder on listing X, the bidding system has begun bidding on behalf of the bidder on listing Y, and the auction on listing X has not yet ended. If, under these circumstances, the bidder enters a manual bid on listing X less favorable than the limit price the bidder specified within the bid group for listing X, in some embodiments, the system may accept this manual bid and may display a warning to the bidder that he/she may in fact eventually be the high bidder on more items (e.g., by virtue of being the high bidder on both listing X and listing Y) than he/she had intended to win initially (e.g., when the big group was created) In some other embodiments, under these circumstances, the system may forbid the entry of the manual bid on listing X, or may present an option to revise the limit price on listing X in the bid group accordingly, in some embodiments canceling the most recent proxy bid on listing Y and possibly continuing proxy bidding on listing X using the newly-entered (less favorable) limit price.

In some embodiments, once it is determined that a bidder cannot be the high bidder on a particular listing in a bidder's bid group and bidding on behalf of the bidder has continued to the next listing in the bid group, under some circumstances it may be possible for the bidding on behalf of a bidder to again occur on that previous listing. For example, if the high bid on that previous listing is canceled, the next lower bid price may be below the bidder's limit price for that previous listing. In some embodiments, that circumstance may result in the most recent bid on a later item being canceled automatically and the bidding on behalf of the bidder again being done with respect to the previous item.

It will be appreciated that in some auctions, a minimum auction increment between bids may be required. In such auctions the conditional of decision box 604 may be to determine whether the current bid on the active listing is less than user's maximum price (or otherwise more favorable to the user) by at least the minimum auction increment for the auction.

It will be appreciated that when two (or more) bidders both include a single auction-format listing into their bid groups and that listing is the active listing simultaneously in both bid groups, a proxy bid “bidding war” may occur between the two bidders, with the system placing proxy bids in the order the listing was added to the various bid groups involved. In some embodiments, however, the system may determine, among the competing bid groups, which has the e.g., highest limit price in an ascending auction and place a single bid on the listing that is higher than the limit prices of the other competing bid groups. In some embodiments, when a bid is placed on a listing, the system may search for all bid groups containing that listing, whereupon, the system may determine the highest qualifying bid among all those bid groups and place that proxy bid on the listing.

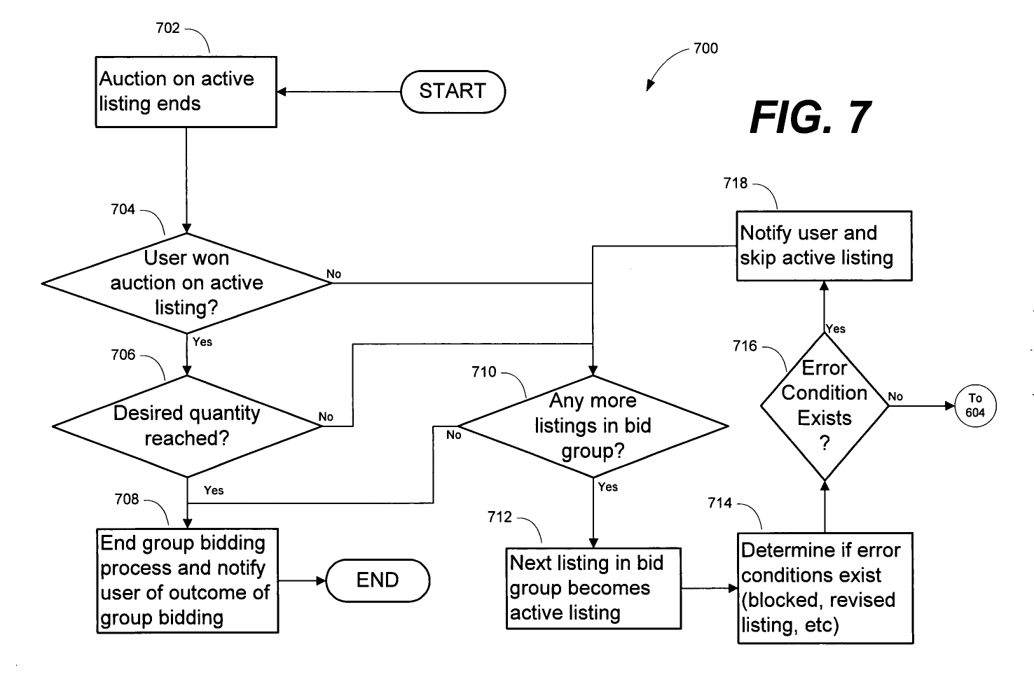

FIG. 7 illustrates a process 700 that may be carried out when the auction on the active listing ends, according to an example embodiment. Process 700 may be carried out by the bid progression module.

At block 702, the auction on the active listing may end. Once the auction on an active listing ends (as determined in some embodiments by End Of Auction (EOA) daemon, described below) the system (in some embodiments, a bid progression module 106) may determine at decision box 704 whether the user won the auction on the active listing.

In some embodiments, when an auction ends by virtue of a system time passing the auction ending time, an EOA daemon may (within a lag type, which may be, for example, one minute) determine that an auction on a listing has in fact ended, and accordingly, may initiate EOA processing. EOA processing may include, for example, transmitting an email notifications to prospective bidder, transmitting an email message to winning bidder(s) if any, billing the entity that offered the listing, and the like.

There may be a lag between the ending time of an auction on a listing and the time the EOA daemon determines that an auction on a listing has in fact ended. This lag may be, in some embodiments, up to one minute. In some embodiments, the bidder may be presented with a message during the creation of a bid group (e.g., during processing in block 202) indicating that such a lag may occur of up to a particular length (e.g., one minute) between the ending of the auction on one listing in a bid group and the commencement of proxy bidding on the next listing in the bid group. In some embodiments, a warning message may be presented to a bidder if the bidder attempts (e.g., during processing associated with block 204, or later addition of listing(s) to a bid group sometime after bid group creation) to include two listings in a bid group whose auction ending times are within the maximum lag time of each other, for example, within one minute.

If it is determined at decision box 704 that the user won the auction on the active listing, the system may evaluate whether the desired quantity of items (if the user has indicated that more than one of the items from the bid group are desired to be obtained) have been won at decision box 706. If the desired quantity has been reached, then at block 708 the group bidding process may be ended and the user notified of the outcome of the group bidding process, such as by an email transmitted via a communication module 104.

If the user did not win the auction on the active listing or if the user did win the auction on the active listing but the desired quantity is not yet reached, processing may continue at decision box 710. At decision box 710, the system (such as via the bid progression module 106) may determine whether there are any more listings in the bid group beyond the active listing. If not, the group bidding process may likewise proceed to block 708 and the group bidding process may be ended with a notification of the user of the outcome of the group bidding. It will be appreciated that there are various ways in which the status and/or outcome of the group bidding process may be communicated to the user. For example, in some embodiments, the user may have an account with the network-based publication system that includes an email address and the user may be notified by email the status of various processes related to the cascade bidding process. In some other embodiments, the user may receive a text or voice message via cell phone or internet telephony.

If at decision box 710 it is determined that there are further listings in the bid group, at block 712, the next listing in the bid group becomes the active listing. Before bidding on behalf of the user on the new active listing may occur, the system may, at block 714, check for error conditions on the new active listing to determine, for example, whether the new active listing is susceptible to having a proxy bid placed on it on behalf of the user. Some examples may include a blockage of the user from bidding on the new active listing such as, for example by a user having a lower feedback rating than is acceptable to the seller of the item, the listing having been removed by the system administrators or the seller, or the listing having been revised by the seller since the new active listing was added to the bid group. Some other reasons that the new active listing may not be susceptible to having a proxy bid placed on it on behalf of the user may include the listing being manually marked as not eligible (e.g., for the user to bid on, or for proxy bidding or cascade bidding in general) such as by the entity offering the listing or by system administrators, or the user's trading limits having been already reached. In some embodiments, bidders may be assigned trading limits that specify a sum that active bids and unpaid closed bids must in total remain below; a listing may be skipped if at the time of processing in block 714, the bidder's trading limit would be exceeded by a proxy bid placed on that listing. Finally, the new active listing may not be susceptible to having a proxy bid placed on it due to the e.g., item described in the listing no longer being available, for example because the entity that placed the listing (or an administrator) removed the listing, or because another bidder may have already exercised an immediate purchase option of the listing, e.g., by bidding the listing's immediate purchase price and accordingly ending the auction earlier than its ending time would have otherwise implied.

In some embodiments, the new active listing may not be susceptible to having a proxy bid place on it if a feedback rating of an entity offering the listing has dropped below the bidder's minimum specified when the listing was added to the bid group, or if the listing was revised and the bidder specified that the listing was revised.

At decision block 716, an evaluation as to whether an error condition exists is made, which may be based on the error condition check of block 714. If an error condition is determined to exist, the new active listing is skipped and processing continues at decision box 710 to determine whether any more listings exist in the bid group. On the other hand, if no error condition exists, the system may become configured to begin proxy bidding on the new active listing on behalf of the user and processing may continue to decision box 604 of FIG. 6.

Example Listing Progression and Bid Group Editing User Interfaces

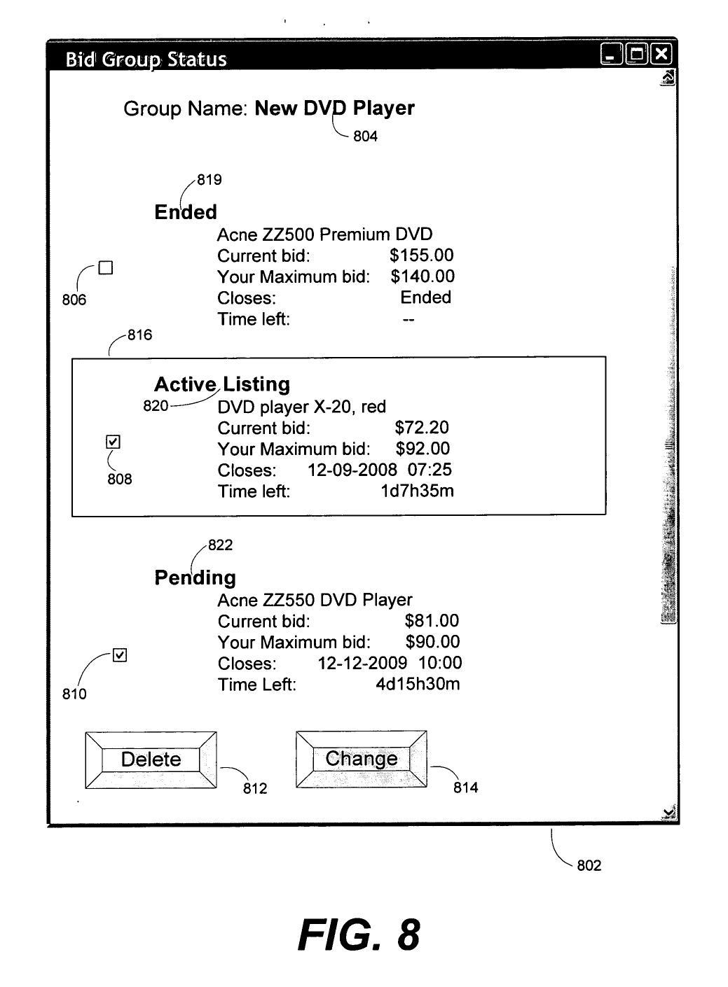

FIG. 8 shows an example user interface that may be used to present the status of the cascade bidding within a bid group to the user to whom the bid group belongs, accordingly to an example embodiment.

In FIG. 8 an example user interface window 802 is shown illustrating bid group status for an example bid group named “New DVD Player” 804. The three auction-format listings illustrated in FIGS. 4 and 5 are shown in FIG. 8. For each of the listings, the title of the listing, the current bid, the user's limit price (e.g., maximum bid price), the time of the auction's closing and the amount of time left before the auction closes are presented. In some embodiments, the status of each listing may be indicated, such as by text labels, and may be accompanied by thumbnail images of each listing item. For example, in user interface window 802, the first auction is indicated as being ended with the “Ended” text label 819. It will be appreciated that with this listing the time until the auction closes is shown as a dash to indicate that the auction has ended. The current active listing may be indicated by the “Active Listing” text label 820 and, in some embodiments, by the presence of a rectangular or highlight box 816. Pending listings (e.g., those not yet, but potentially to be, bid upon on behalf of the user) indicated by a “Pending” text label 822.

In some embodiments, adjacent to each listing information block may be placed checkboxes such as checkboxes 806, 808 and 810 or other selection user interface elements. The user may, in some embodiments, by using a delete button 812, delete selected listings that may be selected by the checkboxes from the bid group. In some embodiments, the user may click on a change button 814 to navigate to a user interface allowing the maximum bid on one or more selected listings to be changed. In some embodiments, the use of this delete button and change button 814 may be used with certain constraints. For example, an active listing in which the current bid is placed on behalf of the user may not be allowed to be deleted, nor a listing for which bidding has already ended. Similarly, in some embodiments, the user may not be permitted to change the user's maximum bid on an ended auction listing.

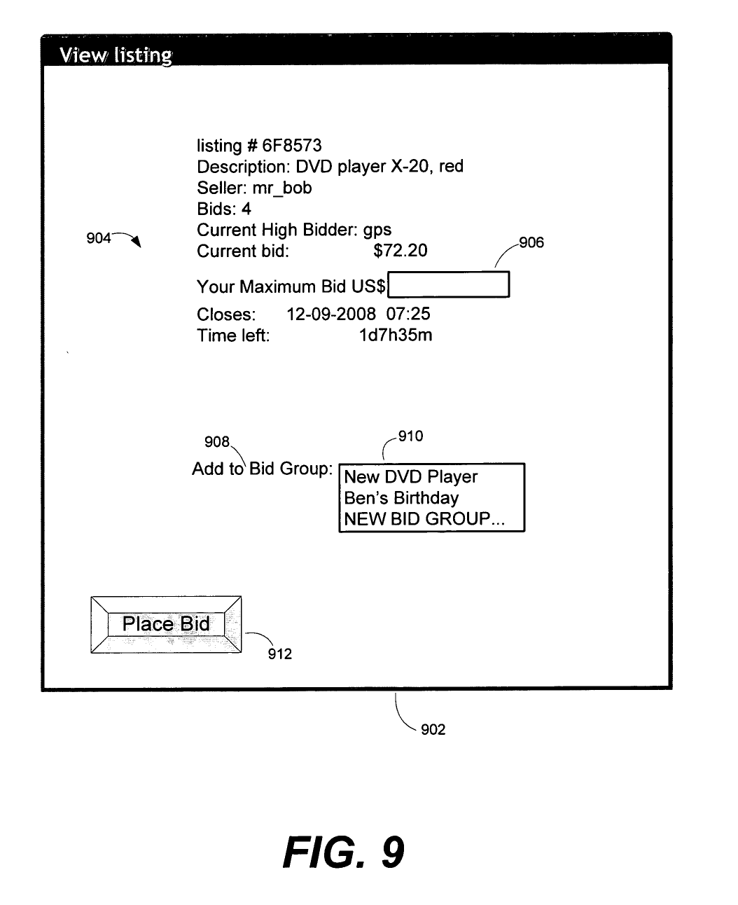

FIG. 9 illustrates a user interface window, screen, or webpage that may be used to add a listing to a new or existing bid group, according to an example embodiment.

User interface window 902 illustrates an example screen or webpage that may be used to allow a user to view an auction format listing in a network-based publication system, such as an online auction system. Listing descriptive information 904 about an auction-format listing may be presented on user interface window 902. Window 902 also includes a text field 906 associated with the listing illustrated, a selectable list 910 of bid groups belonging to the user, a text label 908 and a bid placement button 912.

Suppose for purposes of illustration that a user wishes to add the ascending auction-format listing “6F8573” displayed in window 902 to a bid group. If the user wanted to add the listing described by descriptive information 904 to an existing bid group such as, for example, the bid group entitled “New DVD Player”, the user may enter a maximum bid into the text field 906, select the “New DVD Player” title from the list 910 and click on the “Place Bid” button 912. Alternatively, if the user wished to create a new bid group, one of the items of which is the item shown by listing descriptive information 904, the user may enter a maximum bid on the listing into text field 906, select the “NEW BID GROUP . . . ” entry from the list 910, and click the “Place Bid” button 912. In response, the system may, in some embodiments, present the user with another screen to allow the naming of the new bid group, prior to or simultaneously with commencement of bidding on the illustrated listing descriptive information 904.

In the preceding sections, a number of user interface windows have been presented by way of example. It will be appreciated that in addition to user interfaces, users may also programmatically create, monitor and modify bid groups in the cascade bidding processes to application program or interfaces via a web-based on non-web-based graphical interface or to various other techniques presenting analogous cascade bidding related functionality to that provided through the user interface as illustrated.

In some embodiments, a “cancellation situation” may occur when, for example, a bidder was not the high bidder (e.g., via proxy bidding) on an earlier auction format listing in the bidder's bid group and proxy bidding accordingly progressed to a later listing in the bid group, but the winning bid on the earlier listing was canceled or retracted so that the high bid on the earlier listing is less than the bidder's limit price on the earlier listing. Accordingly, the earlier listing may be suitable for another attempt at bidding on behalf of the bidder.

In some embodiments, the system may cancel the bidder's current bid on the later listing and attempt to proxy bid again on the earlier listing. It will be appreciated that this may cause a cascade of cancellations of other bidder's bids on even later listings for bidders who also include the later listing in their bid groups.

In some embodiments, in a cancellation situation, a bidder may receive (e.g., by email) a “second chance offer”, explaining the cancellation situation and inviting the bidder to request that proxy bidding recommence on the earlier listing. The second chance offer may include a message that by accepting the offer, the bidder may end up being the winning bidder on both the later and the earlier listing. If, by the time the bidder responds to the second chance offer, the bidder has already won a later auction in the bid group, and the buyer's desired quantity of that item has been satisfied, the system may automatically invalidate the second chance offer, and may also automatically notify the entity that placed the listing of this decision, so that the entity may then proceed with making a second chance offer to some other bidder, or to re-list the item, or take some other action.

In some embodiments, upon the acceptance of the second chance offer, the bid group may be made inactive, or canceled, and any current bid placed on behalf of the bidder on the later listing may be retracted.

Example Data Structures

FIG. 10 illustrates database tables that may be used in the implementation of cascade bidding, according to an example embodiment. FIG. 10 illustrates five example tables as they may be implemented using a relational database. An items table 1002 may be used to store information about auction format listings such as for example listings of items offered by sellers for bidding. For each entry in the items table 1002, an item ID, an item title, one or more images of an item, the item's reserved price, the item's seller and various other pieces of data related to a particular item may be included. The bids table 1004 may contain information describing bids placed on auction format listings described in the items table. The bids table may include an entry for each bid placed on an auction format listing in the items table. These bids may include the name, alias or other identification for the bidder, the bid price, the identity of the listing to which the bid pertains, an indication of whether a bid is the current (e.g., in case of an ascending auction, the current high) bid. In some embodiments, both manually placed bids and bids placed by, for example, a bid placement module 108 may be stored in the bids table and may be marked as to the origin of the bid.

A bid groups table 1008 may be used to store information about the bid groups belonging to or otherwise associated with the various users of the network-based publication system.

The bid groups table 1008 may include a number of columns such as, for example, a group ID column 1010, a user identification column 1012, a column to store the title of the bid groups 1014 and a count remain column 1016. The count remain column may be used when a user desires to obtain multiple items in a bid group and may be initialized to the total number of items the user wishes to obtain and decremented each time a user wins one of the auction format listings in the bid group.

A users table 1009 may contain information about, in some embodiments, all, users. A user id column in the users table may serve as a reference key for the user column in the bid groups table 1008.

The bid group entries table 1006 may, in some embodiments, store an entry (e.g., a row) for each listing in each bid group. The group ID column 1018 may provide a reference to the group in the bid groups table 1008 to which the bid group entry in that row pertains. The bid group entries table 1006 may include a listing ID column 1020 that serves as a key or reference to the auction format listing in the items table 1002 to which the bid group entry pertains. The bid group entries table 1006 may also include a limit price column 1022 to indicate, for example, the maximum bid that may be placed on behalf of a user. The bid group entries table 1006 may include a date column 1024 that may include a timestamp when a particular bid group entry was placed for bidding and may include a status column 1026 that may store the status of the entries. Some status values may include active, pending, skipped, closed and the like depending on where in a progression the bid group that includes the particular entry is.

The example presented here illustrates how the bid group entries table 1006 and bid groups table 1008 may be used in an example embodiment. Reference is made to Table 1 and Table 2, below.

TABLE 1
Example Bid Group Table

| Group ID | user | Title | Count remain |
|---|---|---|---|
| Grp21 | Mr_Bob | New DVD Player | 2 |
| Grp302 | wbm | Ben's Birthday | 1 |

TABLE 2
Example Bid Group Entries Table

| Group ID | Listing ID | Limit price | Date placed | status |
|---|---|---|---|---|
| Grp21 | 5A3456 | $100.00 | 3/12/06 2:21 pm | closed |
| Grp21 | 6F3977 | $95.00 | 3/12/06 2:25 pm | active |
| Grp21 | EW4112 | $95.00 | 3/13/06 7:30 pm | pending |
| Grp21 | 3R1234 | $110.00 | 3/13/06 7:30 pm | pending |
| Grp302 | 8J9014 | $45.00 | 3/12/06 2:08 pm | closed |
| Grp302 | 6F3977 | $85.00 | 3/12/06 2:10 pm | active |

Suppose for purposes of example, that a current bid had just been placed on item “6F3977” with a current bid price $72.50. The bid progression module 106, may in response, determine whether any entries in the bid group entries table 1006 are active with respect to that item ID and have a limit price less favorable (e.g., higher) than the current bid price. If there is more than one such entry, the earliest one that is on behalf of another user than the current bid (e.g., a person may not be allowed to proxy bid against themselves) may be used to place the next proxy bid on the item. In this example, that entry is

| | | | | |
|---|---|---|---|---|
| Grp302 | 6F3977 | $85.00 | 3/12/06 2:10 pm | active |

### On behalf of user wbm.

On the other hand, suppose for purposes of example, that a current bid had just been placed on item “6F3977” with a current bid price $88.60. The bid progression module 106, may in response, determine whether any entries in the bid group entries table 1006 are active with respect to that item ID and have a limit price less favorable (e.g., higher) than the current bid price. In this example, only the entry

| | | | | |
|---|---|---|---|---|
| Grp21 | 6F3977 | $95.00 | 3/12/06 2:25 pm | active |

meets these criteria, as the other entry on item “6F3977” in Table 2 has a limit price (e.g., maximum bid price) less than the current bid price $88.60.

In the examples discussed above, it is assumed that the minimum auction increment between bids on an auction-format listing is $0.01. In some embodiments, however, there is a minimum auction increment. For example, suppose for purposes of example, that a current bid had just been placed on item “6F3977” with a current bid price $93.00 and a minimum auction increment of $5.00. In that case, the next bid placed must be at least $98.00—higher than either of the limit prices on that item in the bid group entries in Table 2.

In some embodiments, it may be possible for a bidder to manually enter a bid on an auction format listing that is already included in one of that bidder's bid groups. If the bidder manually places a bid more favorable to him/herself on an active listing than the limit price set in the bid group, then although this newly-placed bid may cause the system to determine at block 602 of FIG. 6 that a new current bid has been placed on the active listing, but may make an evaluation that the new current bid is a bidder's own bid and not attempt to bid on behalf of the bidder, in effect, against him/herself rather than continuing to decision box 604.

Example Summary Processes Used in Cascade Bidding

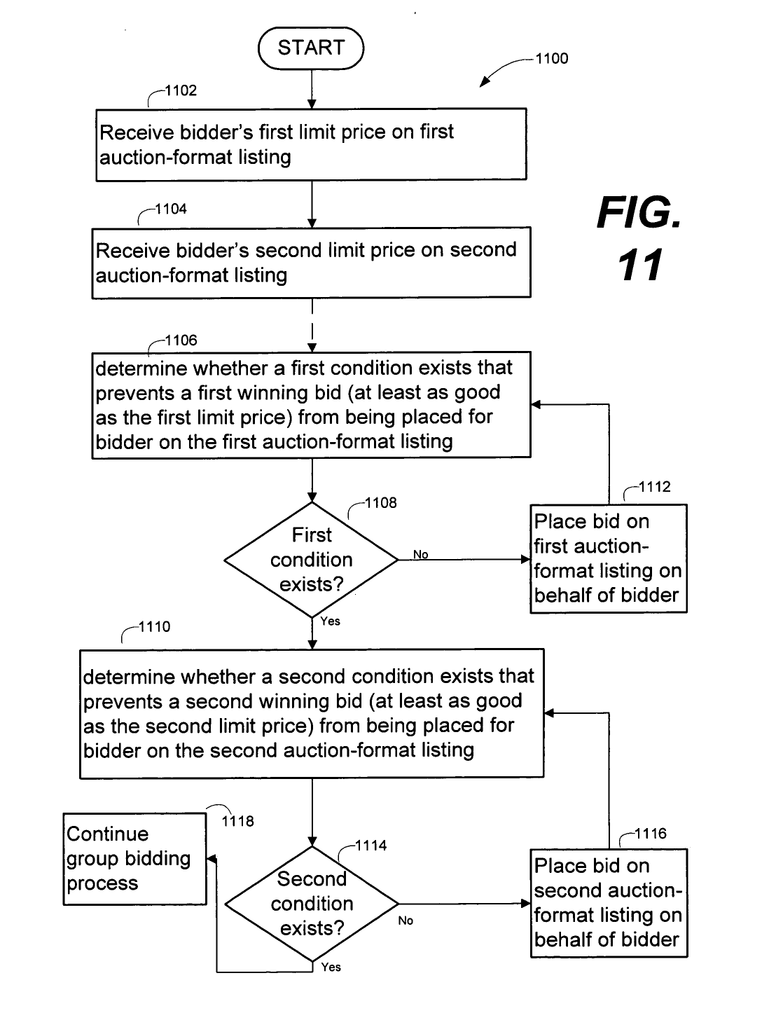

FIG. 11 is a flowchart showing in summary a cascade bidding process within a cascade bidding system, according to an example embodiment. The process illustrated in FIG. 11 may be designated generally as 1100. At block 1102, a network-based publication system (such as, for example, via a communication module 104) may receive a first limit price associated with a bidder on a first auction format listing and at block 1104, the system may receive a second limit price associated with a bidder on a second auction format listing.

Sometime later in the cascade bidding process, at block 1106, the system (such as, for example, using a bid progression module) may make a first determination as to whether a first condition exists that prevents the first winning bid from being placed on behalf of the bidder on the first auction format listing wherein the first winning bid is at least as favorable to the first bidder as the first limit price. At decision box 1108, a determination is made as to whether this first condition exists and based on this first condition existing (e.g., the determination of block 1106 being found to be false) the system may selectively place a bid on the first auction format listing on behalf of the bidder after determining or otherwise assuring that the current bid on that auction format listing was not placed on behalf of the bidder. In other words, the system need not place a proxy bid on a particular auction format listing on behalf of a bidder if the current bid was placed by or on behalf of that same bidder.

If, in block 1108 it is determined that the first condition exists that prevents a first winning bid in being placed on behalf of the bidder on the first auction format listing, processing may be continue at block 1110, for example, as a result of advancing the active item in a particular bid group to the next active listing in the bid group. The system (e.g., by use of the bid progression module 106) may thereafter make at block 1110 a second determination as to whether a second condition exists that prevents a second winning bid from being placed on behalf of the bidder on the second auction format listing wherein the second winning bid is at least as favorable to the first bidder as the second limit price.

At decision box 1114, the system (such as by using a bid progression module 106) may check whether the second condition exists and if not, the system (such as by use of a bid placement module 108) may place a bid on the second auction format listing on behalf of the bidder. If the second condition does exist, processing may continue at block 1118, continuing the group bidding process by, in some embodiments, advancing the active listing to the next listing in the bid group or determining that no further listings remain a potential bidding on behalf of the bidder.

FIG. 12 is a flowchart illustrating a process 1200 as may be carried out by a communication module 104, according to an example embodiment.

At block 1202, a communication module may receive a first limit price with respect to the first auction format listing from a bidder and at block 1204, the communication module may receive a second limit price with respect to the second auction format listing from the bidder. At block 1206, the communication module may receive an indication that the bidder requests that a network-based publication system carry out a method including: attempting to place a first bid with respect to a first auction format listing having a price no less favorable to the bidder in the first limit price, making a determination as to whether the bidder is the winning bidder with respect to the first auction format listing, and based on the determination being in the negative, selectively attempting on behalf of the bidder to place a second bid with respect to the second auction format listing having a price no less favorable to the bidder than the second limit price. It will be appreciated that the receiving the indication in block 1206 may be through the use of a webpage button (such as for example continue button 412) or other user interface component in a user interface, through an analogous message or signal transmitted through an application programming interface, or through some other medium such as a text message on a cell phone.

At block 1208, in response to the data received at blocks 1202, 1204 and 1206, the system such as, for example, by using a bid progression module 106 and a bid placement module 108 may attempt to carry out group bidding according to the bidder's limit price and listing selections.

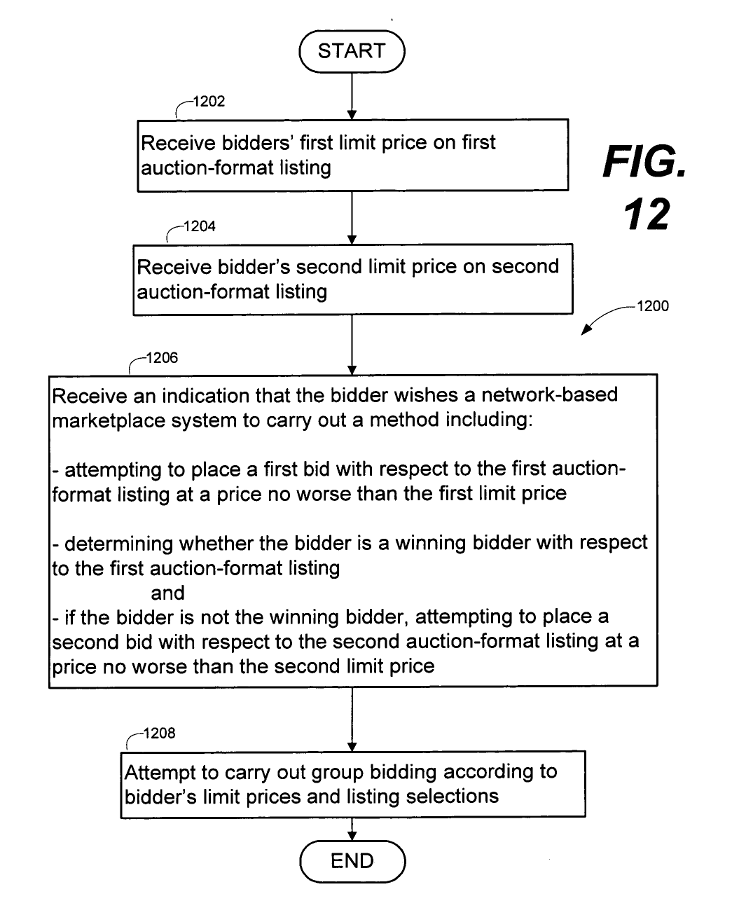

FIG. 13 shows a summary flowchart for a process 1300 for transmitting data facilitating cascade bidding on behalf of the bidder, according to an example embodiment.

At blocks 1302 and 1304, a first limit price with respect to a first auction format listing and a second limit price with respect to a second auction format listing, respectively, may be transmitted to a network-based publication system such as an online auction system. At block 1306, an indication that it is requested that the network-based publication system carry out a method where the method includes: attempting to place a first bid with respect to the first auction format listing having a price not less favorable to the bidder than the first limit price, making a determination as to whether the first bid is a winning bid with respect to the first auction format listing, and based on the determination being in the negative, selectively attempting to place a second bid with respect to the second auction format listing having a price not less favorable to the bidder than the second limit price.

Process 1300 may in some embodiments be carried by a computer or other device associated with the bidder and some embodiments, by transmitting the limit prices auction format listing selection indications and indication of the bidder's wish or request for the network-based publication system to carry out the method by transmission over a network such as, for example, the internet.

Example Platform Architecture

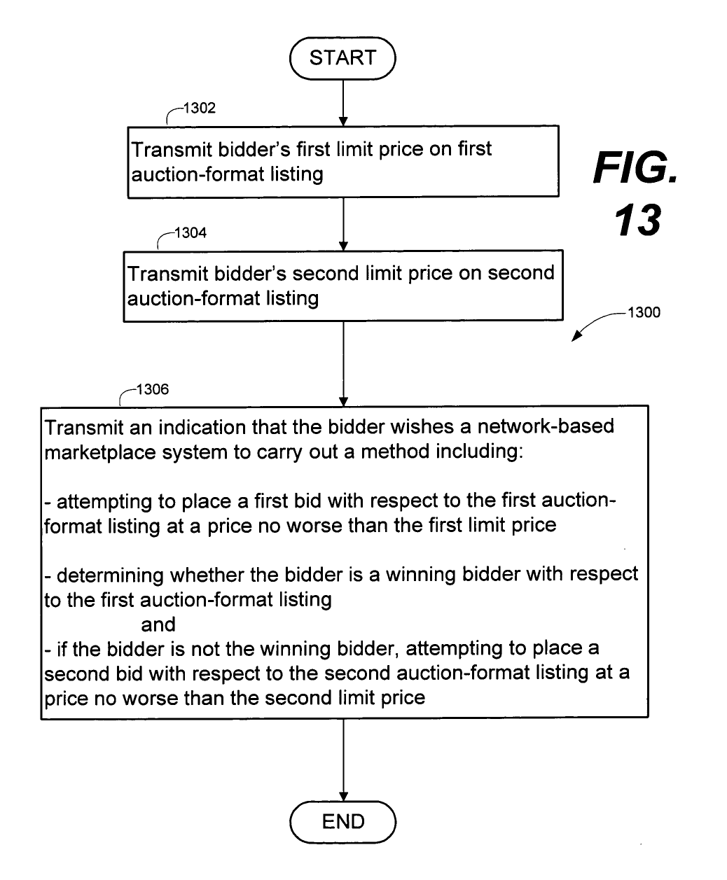

FIG. 14 is a network diagram depicting a client-server system 1400, within which one example embodiment may be deployed. A networked system 1402, in the example forms of a network-based marketplace or publication system, provides server-side functionality, via a network 1404 (e.g., the Internet or Wide Area Network (WAN)) to one or more clients. FIG. 14 illustrates, for example, a web client 1406 (e.g., a browser, such as the Internet Explorer browser developed by Microsoft Corporation of Redmond, Wash. State), and a programmatic client 1408 executing on respective client machines 1410 and 1412.

An Application Program Interface (API) server 1414 and a web server 1416 are coupled to, and provide programmatic and web interfaces respectively to, one or more application servers 1418. The application servers 1418 host one or more marketplace applications 1420 and payment applications 1422. The application servers 1418 are, in turn, shown to be coupled to one or more databases servers 1424 that facilitate access to one or more databases 1426.

The marketplace applications 1420 may provide a number of marketplace functions and services to users that access the networked system 1402. The payment applications 1422 may likewise provide a number of payment services and functions to users. The payment applications 1422 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1420. While the marketplace and payment applications 1420 and 1422 are shown in FIG. 14 to both form part of the networked system 1402, it will be appreciated that, in alternative embodiments, the payment applications 1422 may form part of a payment service that is separate and distinct from the networked system 1402.

Further, while the system 1400 shown in FIG. 14 employs a client-server architecture, the present invention is of course not limited to such an architecture, and could equally well find application in embodiments of a distributed, or peer-to-peer, architecture system, for example. The various marketplace and payment applications 1420 and 1422 could also be implemented as standalone software programs, which do not necessarily have networking capabilities.

The web client 1406 accesses the various marketplace and payment applications 1420 and 1422 via the web interface supported by the web server 1416. Similarly, the programmatic client 1408 accesses the various services and functions provided by the marketplace and payment applications 1420 and 1422 via the programmatic interface provided by the API server 1414. The programmatic client 1408 may, for example, be a seller application (e.g., the TurboLister application developed by eBay Inc., of San Jose, Calif.) to enable sellers to author and manage listings on the networked system 1402 in an off-line manner, and to perform batch-mode communications between the programmatic client 1408 and the networked system 1402.

FIG. 14 also illustrates a third party application 1428, executing on a third party server machine 1430, as having programmatic access to the networked system 1402 via the programmatic interface provided by the API server 1414. For example, the third party application 1428 may, utilizing information retrieved from the networked system 1402, support one or more features or functions on a website hosted by the third party. The third party website may, for example, provide one or more promotional, marketplace or payment functions that are supported by the relevant applications of the networked system 1402.

Marketplace Applications

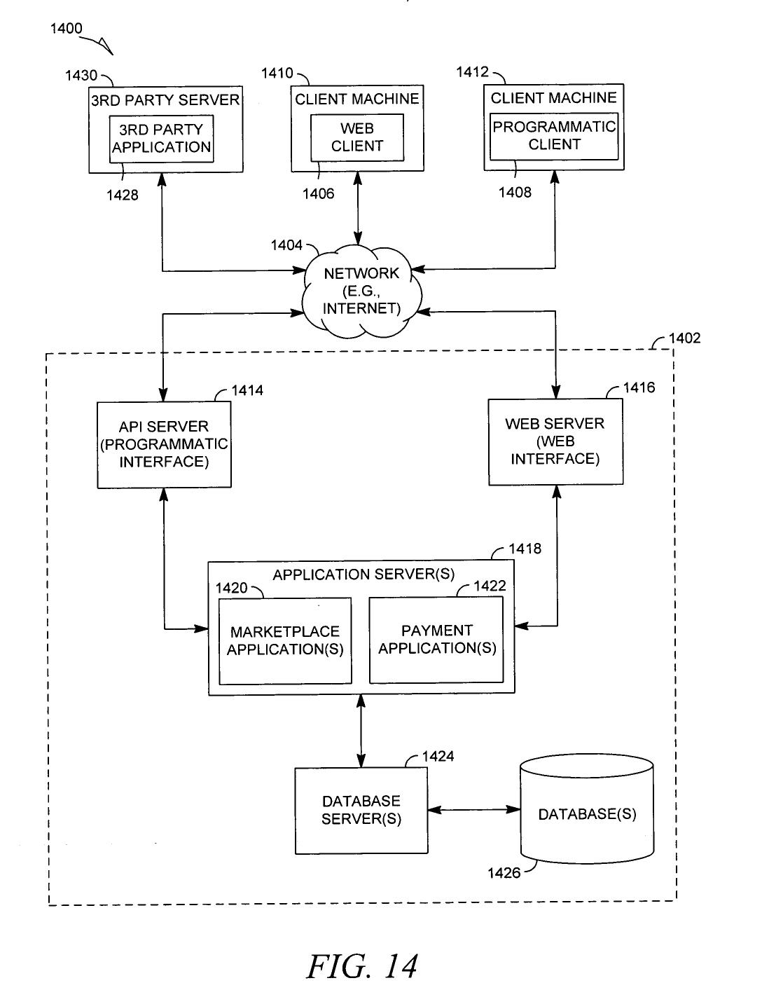

FIG. 15 is a block diagram illustrating multiple applications 1420 and 1422 that, in one example embodiment, are provided as part of the networked system 1402. The applications 1420 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 1426 via the database servers 1424.

The networked system 1402 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 1420 are shown to include at least one publication application 1500 and one or more auction applications 1502 (which may include a bid progression module 106 and a bid placement module 108) which support auction-format listing and price setting mechanisms (e.g., English, Dutch, Vickrey, Chinese, Double, Reverse auctions etc.). The various auction applications 1502 may also provide a number of features in support of such auction-format listings, such as a reserve price feature whereby a seller may specify a reserve price in connection with a listing and a proxy-bidding feature whereby a bidder may invoke automated proxy bidding.

A number of fixed price applications 1504 support fixed price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed price that is typically higher than the starting price of the auction.

Store applications 1506 allow a seller to group listings within a “virtual” store, which may be branded and otherwise personalized by and for the seller. Such a virtual store may also offer promotions, incentives and features that are specific and personalized to a relevant seller.

Reputation applications 1508 allow users that transact, utilizing the networked system 1402, to establish, build and maintain reputations, which may be made available and published to potential trading partners. Consider that where, for example, the networked system 1402 supports person-to-person trading, users may otherwise have no history or other reference information whereby the trustworthiness and credibility of potential trading partners may be assessed. The reputation applications 1508 allow a user, for example through feedback provided by other transaction partners, to establish a reputation within the networked system 1402 over time. Other potential trading partners may then reference such a reputation for the purposes of assessing credibility and trustworthiness.

Personalization applications 1510 allow users of the networked system 1402 to personalize various aspects of their interactions with the networked system 1402. For example a user may, utilizing an appropriate personalization application 1510, create a personalized reference page at which information regarding transactions to which the user is (or has been) a party may be viewed. Further, a personalization application 1510 may enable a user to personalize listings and other aspects of their interactions with the networked system 1402 and other parties.

Embodiments of the networked system 1402 may support a number of marketplaces that are customized, for example, for specific geographic regions. A version of the networked system 1402 may be customized for the United Kingdom, whereas another version of the networked system 1402 may be customized for the United States. Each of these versions may operate as an independent marketplace, or may be customized (or internationalized) presentations of a common underlying marketplace. The networked system 1402 may accordingly include a number of internationalization applications 1512 that customize information (and/or the presentation of information) by the networked system 1402 according to predetermined criteria (e.g., geographic, demographic or marketplace criteria). For example, the internationalization applications 1512 may be used to support the customization of information for a number of regional websites that are operated by the networked system 1402 and that are accessible via respective web servers 1416.

Navigation of the networked system 1402 may be facilitated by one or more navigation applications 1514. For example, a search application (as an example of a navigation application) may enable key word searches of listings published via the networked system 1402. A browse application may allow users to browse various category, catalogue, or inventory data structures according to which listings may be classified within the networked system 1402. Various other navigation applications may be provided to supplement the search and browsing applications.

In order to make listings, available via the networked system 1402, as visually informing and attractive as possible, the marketplace applications 1420 may include one or more imaging applications 1516 utilizing which users may upload images for inclusion within listings. An imaging application 1516 also operates to incorporate images within viewed listings. The imaging applications 1516 may also support one or more promotional features, such as image galleries that are presented to potential buyers. For example, sellers may pay an additional fee to have an image included within a gallery of images for promoted items.

Listing creation applications 1518 allow sellers conveniently to author listings pertaining to goods or services that they wish to transact via the networked system 1402, and listing management applications 1520 allow sellers to manage such listings. Specifically, where a particular seller has authored and/or published a large number of listings, the management of such listings may present a challenge. The listing management applications 1520 provide a number of features (e.g., auto-relisting, inventory level monitors, etc.) to assist the seller in managing such listings. One or more post-listing management applications 1522 also assist sellers with a number of activities that typically occur post-listing. For example, upon completion of an auction facilitated by one or more auction applications 1502, a seller may wish to leave feedback regarding a particular buyer. To this end, a post-listing management application 1522 may provide an interface to one or more reputation applications 1508, so as to allow the seller conveniently to provide feedback regarding multiple buyers to the reputation applications 1508.

Dispute resolution applications 1524 provide mechanisms whereby disputes arising between transacting parties may be resolved. For example, the dispute resolution applications 1524 may provide guided procedures whereby the parties are guided through a number of operations in an attempt to settle a dispute. In the event that the dispute cannot be settled via the guided procedures, the dispute may be escalated to a third party mediator or arbitrator.

A number of fraud prevention applications 1526 implement fraud detection and prevention mechanisms to reduce the occurrence of fraud within the networked system 1402.

Messaging applications 1528 (such as, for example, communication module 104) are responsible for the generation and delivery of messages to users of the networked system 1402, such messages for example advising users regarding the status of listings at the networked system 1402 (e.g., providing “outbid” notices to bidders during an auction process or to provide promotional and merchandising information to users). Respective messaging applications 1528 may utilize any one have a number of message delivery networks and platforms to deliver messages to users. For example, messaging applications 1528 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1530 support various merchandising functions that are made available to sellers to enable sellers to increase sales via the networked system 1402. The merchandising applications 80 also operate the various merchandising features that may be invoked by sellers, and may monitor and track the success of merchandising strategies employed by sellers.

The networked system 1402 itself, or one or more parties that transact via the networked system 1402, may operate loyalty programs that are supported by one or more loyalty/promotions applications 1532. For example, a buyer may earn loyalty or promotions points for each transaction established and/or concluded with a particular seller, and be offered a reward for which accumulated loyalty points can be redeemed.

Example Data Structures

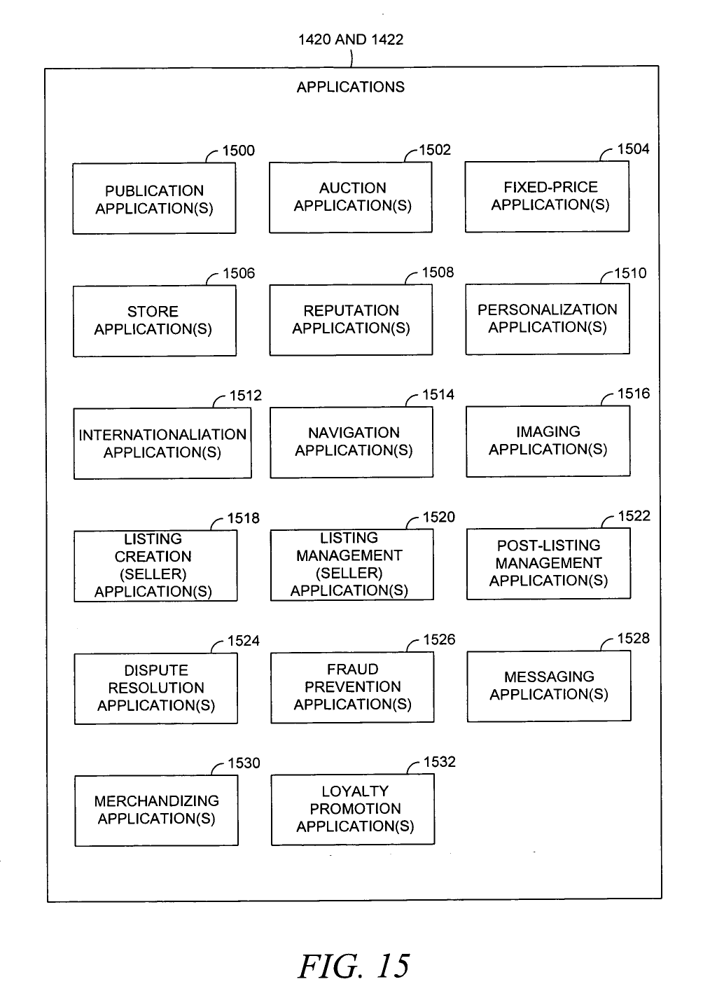

FIG. 16 is a high-level entity-relationship diagram, illustrating various tables 1600 that may be maintained within the databases 1426, and that are utilized by and support the applications 1420 and 1422. A users table 1602 contains a record for each registered user of the networked system 1402, and may include identifier, address and financial instrument information pertaining to each such registered user. A user may operate as a seller, a buyer, or both, within the networked system 1402. In one example embodiment, a buyer may be a user that has accumulated value (e.g., commercial or proprietary currency), and is accordingly able to exchange the accumulated value for items that are offered for sale by the networked system 1402.

The tables 1600 also include an items table 1604 in which are maintained item records for goods and services that are available to be, or have been, transacted via the networked system 1402. Each item record within the items table 1604 may furthermore be linked to one or more user records within the users table 1602, so as to associate a seller and one or more actual or potential buyers with each item record.

A transaction table 1606 contains a record for each transaction (e.g., a purchase or sale transaction) pertaining to items for which records exist within the items table 1604.

An order table 1608 is populated with order records, each order record being associated with an order. Each order, in turn, may be with respect to one or more transactions for which records exist within the transaction table 1606.

Bid records within a bids table 1610 each relate to a bid received at the networked system 1402 in connection with an auction-format listing supported by an auction application 1502. A feedback table 1612 is utilized by one or more reputation applications 1508, in one example embodiment, to construct and maintain reputation information concerning users. A history table 1614 maintains a history of transactions to which a user has been a party. One or more attributes tables 1616 record attribute information pertaining to items for which records exist within the items table 1604. Considering only a single example of such an attribute, the attributes tables 1616 may indicate a currency attribute associated with a particular item, the currency attribute identifying the currency of a price for the relevant item as specified in by a seller.

In addition, in some embodiments, a bid group table 1618 and a bid group entries table 1620, as described in detail above, may also be maintained within the databases 1426 With reference to FIG. 1, in some embodiments the part of store 103 for storing auction format listings may be implemented within the items table 1604. The storage area 118 may in some embodiments be stored in or implemented by the bids table 1610. The store 102 may in some embodiments be implemented using the bid group table 1618 and the bid group entries table 1620.

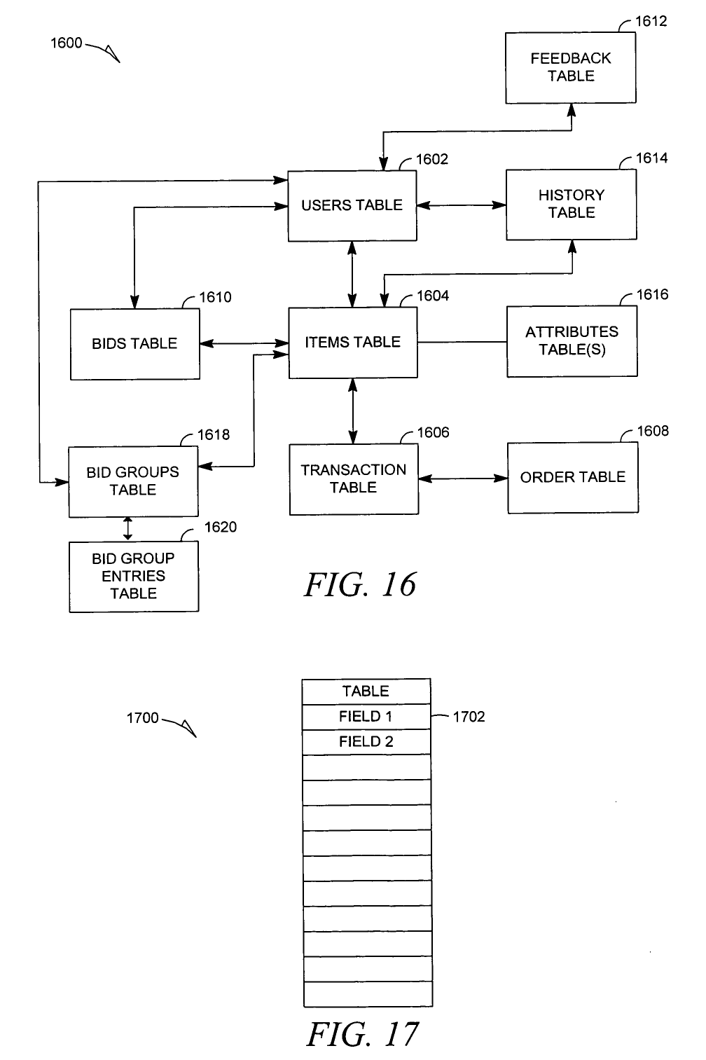

FIG. 17 provides further details regarding pertinent tables that are shown in FIG. 16 to be maintained within the databases 1426.

Example Computer Systems for Carrying Out Operations

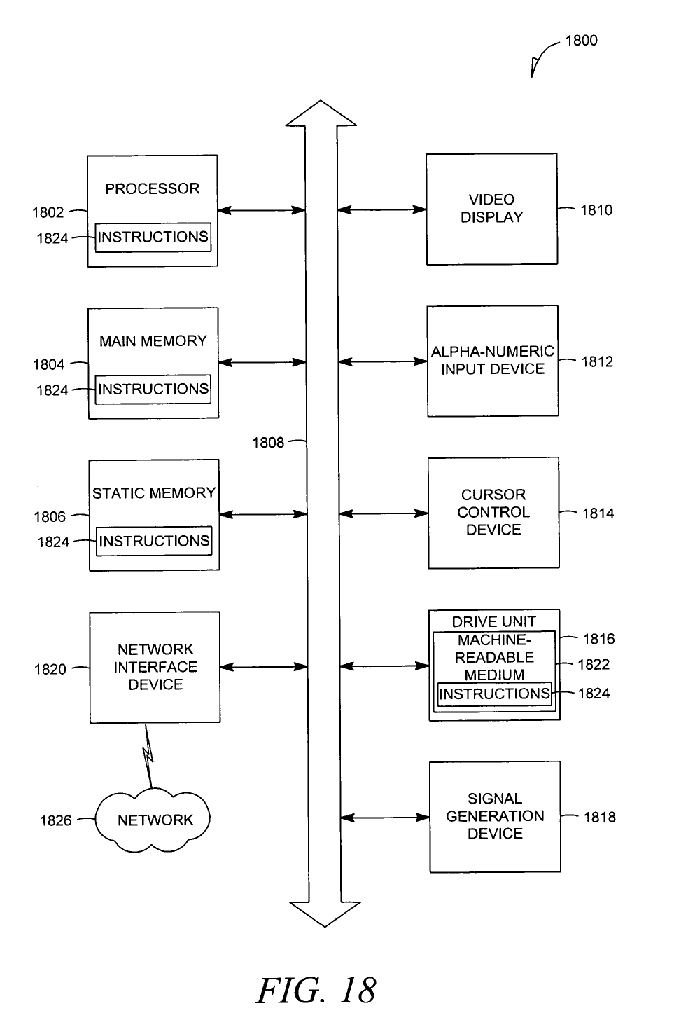

FIG. 18 shows a diagrammatic representation of machine in the example form of a computer system 1800 within which a set of instructions, for causing the machine to perform any one or more of the methodologies, processes, or operations discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU) a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a cursor control device 1814 (e.g., a mouse), a disk drive unit 1816, a signal generation device 1818 (e.g., a speaker) and a network interface device 1820.

The disk drive unit 1816 includes a machine-readable medium 1822 on which is stored one or more sets of instructions (e.g., software 1824) embodying any one or more of the methodologies or functions described herein. The software 1824 may also reside, completely or at least partially, within the main memory 1804 and/or within the processor 1802 during execution thereof by the computer system 1800, the main memory 1804 and the processor 1802 also constituting machine-readable media.

The software 1824 may further be transmitted or received over a network 1826 via the network interface device 1820.

While the machine-readable medium 1822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to [INSERT] have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system including:
a communication module to receive a first limit price associated with a bidder, on a first auction-format listing and to receive a second limit price, associated with the bidder, on a second auction-format listing; and
a bid progression module to make a first determination as to whether a first condition exists that prevents a first winning bid from being placed on behalf of the bidder on the first auction-format listing, the first winning bid being at least as favorable to the bidder as the first limit price, and selectively to make, based on the first determination being in the affirmative, a second determination as to whether a second condition exists that prevents a second winning bid from being placed on behalf of the bidder on the second auction-format listing, the second winning bid being at least as favorable to the bidder as the second limit price.

2. The system of claim 1, wherein the first condition is selected from the group including the bidder not winning the first auction-format listing, a reserve price on the first auction-format listing being less favorable to the bidder than the first limit price, a current bid on the first auction-format listing being less favorable to the bidder than the first limit price, a current bid on the first auction-format listing being more favorable to the bidder than the first limit price by less than a minimum auction increment, the bidder being ineligible to place a bid on the first auction-format item, the first auction-format item not being susceptible to the placement of a bid, and combinations thereof.

3. The system of claim 1, wherein the second condition is selected from the group including the bidder not winning the second auction-format listing, a reserve price on the second auction-format listing being less favorable to the bidder than the second limit price, a current bid on the second auction-format listing being less favorable to the bidder than the second limit price, a current bid on the second auction-format listing being more favorable to the bidder than the second limit price by less than a minimum auction increment, the bidder being ineligible to place a bid on the second auction-format item, the second auction-format item not being susceptible to the placement of a bid, and combinations thereof.

4. The system of claim 1, wherein the bid progression module is to make a third determination as to whether a first current bid associated with the first auction-format listing was placed on behalf of the bidder, and wherein the system includes a bid placement module selectively to place, based on the third determination being in the negative, a first new bid on behalf of the bidder on the first auction-format listing, the price of the first new bid being at least as favorable to the bidder as the first limit price.

5. The system of claim 4, wherein the first auction-format listing includes a fixed price purchase option and a first fixed price, and wherein the first new bid is equal to the first fixed price.

6. The system of claim 1, wherein the bid progression module is to make a fourth determination as to whether a second current bid associated with the second auction-format listing was placed on behalf of the bidder, and wherein the system includes a bid placement module selectively to place, based on the first determination being in the affirmative and the fourth determination being in the negative, a second new bid on behalf of the bidder on the second auction-format listing, the price of the second new bid being at least as favorable to the bidder as the second limit price.

7. The system of claim 6, wherein the second auction-format listing includes a fixed price purchase option and a second fixed price, and wherein the second new bid is equal to the second fixed price.

8. The system of claim 1, wherein the first limit price is the same as the second limit price.

9. The system of claim 1, wherein an item described by the first auction-format and an item described by the second auction-format listing are essentially the same item.

10. A system including:
a communication module to receive from a bidder a first limit price with respect to a first auction-format listing, and to receive from the bidder a second limit price with respect to a second auction-format listing, and to receive an indication that the bidder requests that a network-based publication system carry out a method, the method including attempting on behalf of the bidder to place a first bid with respect to the first auction-format listing having a price no less favorable to the bidder than the first limit price, making a determination as to whether the bidder is a winning bidder with respect to the first auction-format listing, based on the determination being in the negative, selectively attempting on behalf of the bidder to place a second bid with respect to the second auction-format listing having a price no less favorable to the bidder than the second limit price.

11. The system of claim 10, wherein the second auction-format listing includes a fixed price purchase option and a fixed price, and wherein the second bid has a price no less favorable to the bidder than the fixed price.

12. The system of claim 10, wherein the first limit price is the same as the second limit price.

13. The system of claim 10, wherein the first auction-format listing is substantially the same auction-format listing as the second auction-format listing.

14. A method including:
receiving a first limit price associated with a bidder, on a first auction-format listing;
receiving a second limit price associated with the bidder, on a second auction-format listing;
making a first determination as to whether a first condition exists that prevents a first winning bid from being placed on behalf of the bidder on the first auction-format listing, the first winning bid being at least as favorable to the bidder as the first limit price;
based on the first determination being in the affirmative:
selectively making a second determination as to whether a second condition exists that prevents a second winning bid from being placed on behalf of the bidder on the second auction-format listing, the second winning bid being at least as favorable to the bidder as the second limit price.

15. The method of claim 14, wherein the first condition is selected from the group including the bidder not winning the first auction-format listing, a reserve price on the first auction-format listing being less favorable to the bidder than the first limit price, a current bid on the first auction-format listing being less favorable to the bidder than the first limit price, a current bid on the first auction-format listing being more favorable to the bidder than the first limit price by less than a minimum auction increment, the first being ineligible to place a bid on the first auction-format item, the first auction-format item not being susceptible to the placement of a bid, and combinations thereof.

16. The method of claim 14, wherein the second condition is selected from the group including the bidder not winning the second auction-format listing, a current bid on the second auction-format listing being less favorable to the bidder than the second limit price, a current bid on the second auction-format listing being more favorable to the bidder than the second limit price by less than a minimum auction increment, a reserve price on the second auction-format listing being less favorable to the bidder than the second limit price, the bidder being ineligible to place a bid on the second auction-format item, the second auction-format item not being susceptible to the placement of a bid, and combinations thereof.

17. The method of claim 14, further including:
making a third determination as to whether a first current bid associated with the first auction-format listing was placed on behalf of the bidder; and
based on the third determination being in the negative, selectively placing a first new bid on behalf of the bidder on the first auction-format listing, the price of the first new bid being at least as favorable to the bidder as the first limit price.

18. The method of claim 17, wherein the first auction-format listing includes a fixed price purchase option and a first fixed price, and wherein the first new bid is equal to the first fixed price.

19. The method of claim 14, further including:
based on the first determination being in the affirmative:
selectively making a fourth determination as to whether a second current bid associated with the second auction-format listing was placed on behalf of the bidder; and
based on the fourth determination being in the negative, selectively placing a second new bid on behalf of the bidder on the second auction-format listing, the price of the second new bid being at least as favorable to the bidder as the second limit price.

20. The method of claim 19, wherein the second auction-format listing includes a fixed price purchase option and a second fixed price, and wherein the second new bid is equal to the second fixed price.

21. The method of claim 14, wherein the first limit price is the same as the second limit price.

22. The method of claim 14, wherein an item described by the first auction-format and an item described by the second auction-format listing are essentially the same item.

23. A method including:
receiving from a bidder a first limit price with respect to a first auction-format listing;
receiving from the bidder a second limit price with respect to a second auction-format listing; and
receiving an indication that the bidder requests that a network-based publication system carry out a method including:
attempting on behalf of the bidder to place a first bid with respect to the first auction-format listing having a price no less favorable to the bidder than the first limit price;
making a determination as to whether the bidder is a winning bidder with respect to the first auction-format listing; and
based on the determination being in the negative, selectively attempting on behalf of the bidder to place a second bid with respect to the second auction-format listing having a price no less favorable to the bidder than the second limit price.

24. The method of claim 23, wherein the second auction-format listing includes a fixed price purchase option and a fixed price, and wherein the second bid has a price no less favorable to the bidder than the fixed price.

25. The method of claim 23, wherein the first limit price is the same as the second limit price.

26. The method of claim 23, wherein an item described by the first auction-format and an item described by the second auction-format listing are essentially the same item.

27. A method including:
transmitting to a network-based publication system on behalf of a bidder a first limit price with respect to a first auction-format listing and a second limit price with respect to a second auction-format listing; and
transmitting to the network-based publication system an indication that it is requested that the network-based publication system carry out a method including:
attempting to place a first bid with respect to the first auction-format listing having a price not less favorable to the bidder than the first limit price;
making a determination as to whether the first bid is a winning bid with respect to the first auction-format listing; and
based on the determination being in the negative, selectively attempting to place a second bid with respect to the second auction-format listing having a price not less favorable to the bidder than the second limit price.

28. The method of claim 27, wherein the first limit price is the same as the second limit price.

29. The method of claim 27, wherein an item described by the first auction-format and an item described by the second auction-format listing are essentially the same item.

30. The method of claim 27, wherein the transmitting of the first limit price is via a web interface.

31. The method of claim 27, wherein the transmitting of the first limit price is via an application programming interface (API)

32. A machine-readable medium embodying instructions, which when executed by a machine, cause the machine to perform a method including:
receiving a first limit price associated with a bidder, on a first auction-format listing;
receiving a second limit price associated with the bidder, on a second auction-format listing;
making a first determination as to whether a first condition exists that prevents a first winning bid from being placed on behalf of the bidder on the first auction-format listing, the first winning bid being at least as favorable to the bidder as the first limit price;
based on the first determination being in the affirmative:
selectively making a second determination as to whether a second condition exists that prevents a second winning bid from being placed on behalf of the bidder on the second auction-format listing, the second winning bid being at least as favorable to the bidder as the second limit price.

33. A machine-readable medium embodying instructions, which when executed by a machine, cause the machine to perform a method including:
receiving from a bidder a first limit price with respect to a first auction-format listing;
receiving from the bidder a second limit price with respect to a second auction-format listing; and
receiving an indication that the bidder requests that a network-based publication system carry out a method including:
attempting on behalf of the bidder to place a first bid with respect to the first auction-format listing having a price no less favorable to the bidder than the first limit price;
making a determination as to whether the bidder is a winning bidder with respect to the first auction-format listing; and
based on the determination being in the negative, selectively attempting on behalf of the bidder to place a second bid with respect to the second auction-format listing having a price no less favorable to the bidder than the second limit price.

34. A machine-readable medium embodying instructions, which when executed by a machine, cause the machine to perform a method including:
transmitting to a network-based publication system on behalf of a bidder a first limit price with respect to a first auction-format listing and a second limit price with respect to a second auction-format listing; and
transmitting to the network-based publication system an indication that it is requested that the network-based publication system carry out a method including:
attempting to place a first bid with respect to the first auction-format listing having a price not less favorable to the bidder than the first limit price;
making a determination as to whether the first bid is a winning bid with respect to the first auction-format listing; and
based on the determination being in the negative, selectively attempting to place a second bid with respect to the second auction-format listing having a price not less favorable to the bidder than the second limit price.
